(19) United States
(12) Patent Application Publication
(10) Pub. No.: US 2026/0138533 A1
(43) Pub. Date: May 21, 2026

(54) METHOD FOR GENERATING A VIEW OF THE SURROUNDINGS, METHOD FOR TRAINING A NEURAL NETWORK, CONTROLLER, VEHICLE AND COMPUTER PROGRAM

(71) Applicant: Continental Autonomous Mobility Germany GmbH, Ingolstadt (DE)

(72) Inventors: Markus Eich, Ulm (DE); Anuradha Pasupathy, Bangalore (IN); Deepanshu Makkar, Ulm (DE)

(73) Assignee: Continental Autonomous Mobility Germany GmbH, Ingolstadt (DE)

(21) Appl. No.: 19/121,017

(22) PCT Filed: Sep. 4, 2023
(86) PCT No.: PCT/DE2023/200177

§ 371 Date: Apr. 14, 2025

(30) Foreign Application Priority Data
Oct. 12, 2022 (DE) 10 2022 210 732.2

(51) Int. Cl. B60R 1/27; G06T 7/11; G06V 10/26; G06V 20/56; H04N 23/90

(52) U.S. Cl. CPC B60R 1/27; G06T 7/11; G06V 10/26; G06V 20/56; H04N 23/90; B60R 2300/105; B60R 2300/304; B60R 2300/8093; G06T 2207/20081; G06T 2207/20084; G06T 2207/30252

(57) ABSTRACT

A method for generating a view of surroundings located behind a trailer of a vehicle, including obtaining images with a camera arrangement, wherein the camera arrangement a first camera capturing at least one section of the trailer as well as a second camera capturing at least one subregion of the surroundings behind the trailer. The method further includes capturing a first camera image with the first camera and at least one second camera image with the second camera, determining at least one segment of the first camera image which corresponds to an end face, directed toward the towing vehicle, of the trailer, in the first camera image by segmenting the first camera image, and generating the surroundings view from the first camera image and the second camera image based on the determined segment, wherein at least part of the segment is supplemented with image data from the second camera image.

### CROSS-REFERENCE TO RELATED APPLICATIONS

The present application is a National Stage Application under 35 U.S.C. § 371 of International Patent Application No. PCT/DE 2023/200177 filed on Sep. 4, 2023, and claims priority from German Patent Application No. 10 2022 210 732.2 filed on Oct. 12, 2022, in the German Patent and Trademark Office, the disclosures of which are herein incorporated by reference in their entireties.

### TECHNICAL FIELD

The invention relates to a method for generating a view of the surroundings located at least partially behind a trailer of a vehicle combination including the trailer and a towing vehicle from camera images obtained with the aid of a camera arrangement, wherein the camera arrangement has at least one first camera capturing at least one section of the trailer as well as at least one second camera capturing at least one subregion of the surroundings behind the trailer. Furthermore, the invention relates to a method for training a neural network, a controller, a vehicle and a computer program.

### BACKGROUND

In the case of a vehicle combination which comprises a towing machine and a trailer, a camera capturing a region behind the towing vehicle such as a back-up camera can only be utilized to a limited extent, since the field of view of the camera is at least partially blocked by the trailer. Furthermore, clear rear visibility is, however, desirable, especially in the case of such a combination since the view of a driver can also be obstructed when turning his head backward or when utilizing a rear-view or side mirror by the trailer.

It is known from the prior art that the images from a back-up camera of the towing vehicle are supplemented by images which are acquired by a camera arranged on the rear of the trailer facing away from the towing vehicle. In this way, a view of the surroundings can be generated in which a part of the surroundings blocked by the trailer becomes visible in the images from the back-up camera by representing the trailer at least partially transparently, so that an at least substantially unblocked representation of the surroundings behind the vehicle is possible.

Such a method is described, for example, in the printed document WO 2021/046379 A1.

To generate a quasi-transparent trailer in the view of the surroundings, it is necessary to know the dimensions of the trailer in order to make it possible to seamlessly join the images from the various cameras together. To this end, it is known that the representation of the trailer in an image from the back-up camera of the towing vehicle is assumed to be a four-sided surface, the dimensions of which are known, for example due to an input of these dimensions by a user of the vehicle combination. The generation of a transparent view of the trailer in the image of the surroundings is, however, limited to box-shaped trailers having known and constant dimensions.

### SUMMARY

An aspect of the present disclosure is to indicate an improved method for generating a view of the surroundings located at least partially behind a trailer of a vehicle combination, which in particular facilitates a deployment of the method with different trailers.

In the case of a method of the type mentioned at the outset that the method includes the following steps:
capturing at least one first camera image with the at least one first camera and at least one second camera image with the second camera,
determining at least one segment of the first camera image which corresponds to an end face, directed toward the towing vehicle, of the trailer, in the first camera image by segmenting the first camera image,
generating the view of the surroundings from the first camera image and the second camera image as a function of the determined segment, wherein at least part of the segment is supplemented with image data from the second camera image.

The first camera can, for example, be arranged on the towing vehicle and capture a region behind the towing vehicle. The first camera can, for example, be a back-up camera of the towing vehicle. The end face of the trailer facing the towing vehicle is depicted on the camera image acquired with the first camera. In particular, the geometry of the end face of the trailer directed toward the towing vehicle depends on a swivel angle between the towing vehicle and the trailer and, in addition to a front or a section of a front of the trailer, can also wholly or at least partially include one or more sides or side surfaces of the trailer. Within the meaning of the present disclosure, the end face of the trailer is not only limited to an end face of the trailer body, but rather can also include a load of the trailer, which is arranged on the trailer and visible from the first camera, for example when the load is arranged on a trailer without a cover or the like.

The segmentation of the first camera image to recognize the end face of the trailer depicted in the first camera image advantageously makes it possible to recognize trailer end faces having any geometry. Due to the segmentation of the first camera image to recognize the representation of the trailer in the first camera image, the trailer can consequently advantageously be recognized independently of a predefined geometry and independently of dimensions entered in advance or provided in some other way and hidden in the view of the surroundings or supplemented with image data from the second camera image. Consequently, an at least partially transparent representation of the trailer can advantageously be achieved in the view of the surroundings in the case of trailers of any shape.

Consequently, in addition to box-shaped trailers, other types of trailers, by way of example trailers for transporting vehicles such as boat trailers, motorcycle trailers, car trailers or similar, with and without a load, can also advantageously be wholly or partially hidden in the view of the surroundings. The same applies to trailers for transporting other loads such as flatbed trailers, trailers for transporting bulk goods or containers and so on, which can likewise have different end faces in the unladen condition as well as in the wholly or partially loaded condition.

A further advantage of the solution according to the present disclosure is that it is possible to dispense with establishing the dimensions of the trailer, for example by means of measuring the trailer. This simplifies the application of the method within the framework of a driver assistance system, since the latter can be used in the case of different trailers without the user inputting trailer dimensions or the like. Further, the method can also be deployed in the case of a trailer both in the unladen state and in differently loaded states without any further intervention.

In particular, individual pixels of the first camera image are allocated to the end face of the trailer depicted in the first camera image by means of the segmentation. A contour enclosing the pixels which encloses the segment can subsequently be determined for the pixels or pixel regions which are determined to belong to the end face of the trailer. Depending on the characteristics of the trailer or its end face, one or more segments can be determined. Pixels of the first camera image which are not allocated to the end face of the trailer can, for example, be allocated to further sections of the trailer and/or the surroundings of the vehicle combination.

The second camera image which is acquired by the second camera shows the surroundings of the vehicle combination behind the trailer. The second camera can be arranged, for example, on a back or a tail of the trailer. The at least one segment determined in the first camera image is subsequently supplemented with image information from the second camera image. The segment can be partially or completely supplemented with image data from the second camera image. The supplementation is carried out in particular in such a way that image sections of the surroundings lying within the segment which cannot be seen in the first camera image due to the trailer are filled in by corresponding image sections of the second camera image. In this way, an image, which is in particular at least substantially distortion-free and continuous, of the surroundings behind the vehicle combination can be generated as a view of the surroundings.

The generation of the view of the surroundings can be carried out as a function of an item of position information which describes the relative arrangement between the first camera and the second camera. In this way, the image data from the second camera image can be inserted into the segment determined in the first camera image in a manner which is as seamless and distortion-free as possible. The position information can in particular describe a spatial offset between the first camera and the second camera, by way of example by a translation and/or a rotation. The position information can be initially predefined and established, by way of example, by a measurement and/or can be determined continuously, in particular during a driving movement of the vehicle combination.

A continuous determination of the position information can, for example, be carried out by odometry and/or by machine vision, by way of example on the basis of an optical flow or of tracked features in the first and/or second camera images. Extrinsic camera parameters of the first camera and/or extrinsic camera parameters of the second camera and/or a vehicle model of the towing vehicle, of the trailer and/or of the vehicle combination can also be used to determine the position information.

The segmentation takes place, in particular continuously, for a plurality of first camera images, in particular for first camera images acquired in a video stream. Accordingly, image data from second camera images, which are likewise continuously acquired, are also supplemented in the continuously determined and segmented first camera images, so that the view of the surroundings can likewise be represented as an image stream or video. The view of the surroundings can be represented, for example, on a display device arranged in the towing vehicle and which can be seen by a driver of the towing vehicle.

According to the present disclosure, it can be provided that a lateral swivel angle of the trailer is determined as a function of the position of one or more edges of the at least one segment in the first camera image as well as the position of a coupling point at which the trailer is laterally swivelably coupled to the towing vehicle, wherein the view of the surroundings is generated as a function of the lateral swivel angle and/or wherein, when a swivel angle limit value is exceeded, a warning is output to a driver of the towing vehicle and/or a control command is output to an actuator of the towing vehicle.

The edges can, for example, be determined with the aid of a line fitting algorithm. The coupling point can be established, by way of example, from a three-dimensional vehicle model stored in a computing device configured to perform the method and/or from the first camera image with the aid of an image recognition algorithm. The advantage of the determination of the lateral swivel angle between the towing vehicle and the trailer, that is to say the angle of a rotation of the trailer around the coupling point, which can occur, for example, during the cornering of the vehicle combination, from the at least one segment determined in the first camera image is that no further apparatuses or algorithms have to be deployed to determine the angle. Consequently, it is advantageously possible to dispense with sensors which measure the swivel angle as well as an additional evaluation of the first camera image and/or further image data.

In a configuration of the present disclosure, it can be provided that the respective intersection points of two lateral edges of the segment, which correspond to the lateral edges of the trailer, having a lower edge of the segment, which corresponds to a lower edge of the trailer, are determined, wherein the lateral swivel angle is determined from a projection of the intersection points and the coupling point onto a ground plane extending parallel to a roadway plane of the vehicle combination.

It is assumed that the towing vehicle and the trailer are moving on the same roadway or on a common plane. Two intersection points can be established from the lateral edges of the trailer, in particular from the lateral edges of a front of the trailer facing the towing vehicle, as well as the lower edge of the trailer, which intersection points depend on the orientation of the trailer with respect to the towing vehicle and consequently on the lateral swivel angle. The intersection points as well as the coupling point can subsequently be projected into the ground plane. The swivel angle can, for example, be determined as the angle between a longitudinal direction of the towing vehicle and a perpendicular from the projection of the coupling point onto the straight line between the projections of the intersection points.

According to the present disclosure, it can be provided that at least one further segment is determined by segmenting the first camera image, wherein the further segment corresponds to a coupling section of the trailer. The representation of the coupling section of the trailer cannot be replaced by the camera image from the second, trailer-side camera, so that this continues to be displayed in the view of the surroundings. Further, the representation of the coupling section also makes it possible for a driver to be able to recognize the current angle between the towing vehicle and the trailer thanks to the depiction of the coupling section in the view of the surroundings, including in particular when the end face of the trailer is represented completely transparently.

In a configuration of the present disclosure, it can be provided that the segmentation of the first camera image is carried out by a neural network and/or that the segmentation of the first camera image is carried out by semantic segmentation, in particular a content-guided network algorithm.

A description of the content-guided network algorithm can be found, for example, in the WU, Tianyi, et al. CGNet article “A Light-Weight Context Guided Network for Semantic Segmentation,” IEEE Transactions on Image Processing, 2020, Vol. 30, pp. 1169-1179. However, the present disclosure is not limited to this type of algorithm; other algorithms for a semantic segmentation of image data can also be deployed for the determination of the at least one segment in the first camera image.

According to the present disclosure, it can be provided that a camera arrangement is used which uses one or more third cameras, which each capture a lateral region surrounding the towing vehicle and/or the trailer, wherein the view of the surroundings is additionally generated from one or more third camera images of the third cameras.

By using one or more third cameras which each capture part of the lateral surroundings of the vehicle combination, the view of the surroundings can be extended so that regions laterally next to and/or to the side behind the vehicle combination can also be depicted.

It is provided for a method according to the present disclosure for training a neural network for the segmentation of an image, in particular for use in a method according to the present disclosure, that it includes the following steps:
providing at least one training data set including multiple training images, which each depict at least one end face, directed toward an acquisition position of the training image, of a trailer as a ground truth,
assigning at least one segment to each of the training images, wherein each segment corresponds to the end face of the trailer in the training image, and
optimizing the neural network in terms of a conformity between the at least one segment and the end face of the trailer described by the ground truth.

A neural network trained according to the method described above can be used in a method according to the present disclosure for generating a view of the surroundings located at least partially behind a trailer of a vehicle combination including the trailer and a towing vehicle. The neural network can be deployed for segmenting the at least one first camera image, so that the at least one segment of the first camera image including the end face of the trailer can advantageously be determined.

A training dataset which includes a plurality of training images is used for training the neural network. An end face, directed toward an acquisition position of the respective training image, of a trailer, which represents a ground truth of the respective training image, can be seen on each of the training images. The training images can be, by way of example, images which have been acquired by the back-up camera of the towing vehicle of a vehicle combination, and on which a trailer of the vehicle combination can be recognized.

At least one segment which corresponds to the end face of the trailer depicted in the respective training image can then be assigned to each of these training images. The neural network can subsequently be trained in such a way that the parameters of the neural network are adapted to a conformity of the segments with the images of the end faces of the trailers, which are provided as ground truth in the training images. The training images include representations of different types of trailers and/or different loading states of trailers.

According to the present disclosure, it can be provided that at least some of the training images depict a coupling section of the trailer as a further ground truth, wherein a further segment is assigned to the coupling section and the neural network is also optimized in terms of a conformity between the at least one further segment and the coupling section described by the further ground truth.

The fact that a ground showing a coupling section of the trailer is also assigned to each of the training images means that the parameters of the neural network can also be advantageously adapted in terms of a conformity between the further segments corresponding to the coupling section and the ground truth. As a result, the neural network is also trained for recognizing coupling sections of trailers.

It is provided for a controller according to the present disclosure that it is configured to receive at least one first camera image and at least one second camera image, wherein the controller is set up to perform a method according to the present disclosure for generating a view of the surroundings.

The controller can in particular be connected to at least one first camera, at least one second camera and, optionally, also to one or more third cameras. The connections between the controller and the cameras can be realized, by way of example, as wired or wireless communication links. This makes it possible for the first camera images, the second camera images as well as, possibly, also the images from the third cameras to be transmitted to the controller.

It is provided for a vehicle according to the present disclosure that it includes a controller according to the present disclosure. The vehicle can be a motor vehicle, for example a passenger car, a truck or a trailer.

A computer program according to the present disclosure includes instructions which prompt a computing device to carry out a method according to the present disclosure. The computer program according to the present disclosure can in particular be saved on a non-transient data carrier or can be retrieved and/or downloaded from a computing device via a communication link, by way of example the internet. The computing device can be, for example, a controller of a vehicle or a computing device external to the vehicle, which communicates with such a controller.

All of the advantages and configurations described above in relation to the method according to the present disclosure for generating a view of the surroundings also apply accordingly to the method according to the present disclosure for training a neural network, the controller according to the present disclosure, the vehicle according to the present disclosure and the computer program according to the present disclosure as well as vice versa in each case.

### BRIEF DESCRIPTION OF THE DRAWINGS

Further advantages and details of the present disclosure are set out by the example embodiments described below as well as with reference to the drawings. These are schematic representations, wherein:

FIG. 1 shows a vehicle combination including an example embodiment of a vehicle according to the present disclosure,

FIG. 2 shows a representation of the relative arrangement of a first camera and a second camera,

FIG. 3 shows an example of a first camera image,

FIG. 4 shows the example of the first camera image after determining the at least one segment,

FIG. 5 shows a graphical representation of a first step of a determination of a swivel angle between a towing vehicle and trailer from the segmented first camera image,

FIG. 6 shows a graphical representation of a second step of the determination of the swivel angle, and

FIG. 7 shows an example embodiment of a method for training a neural network for the segmentation of an image.

### DETAILED DESCRIPTION

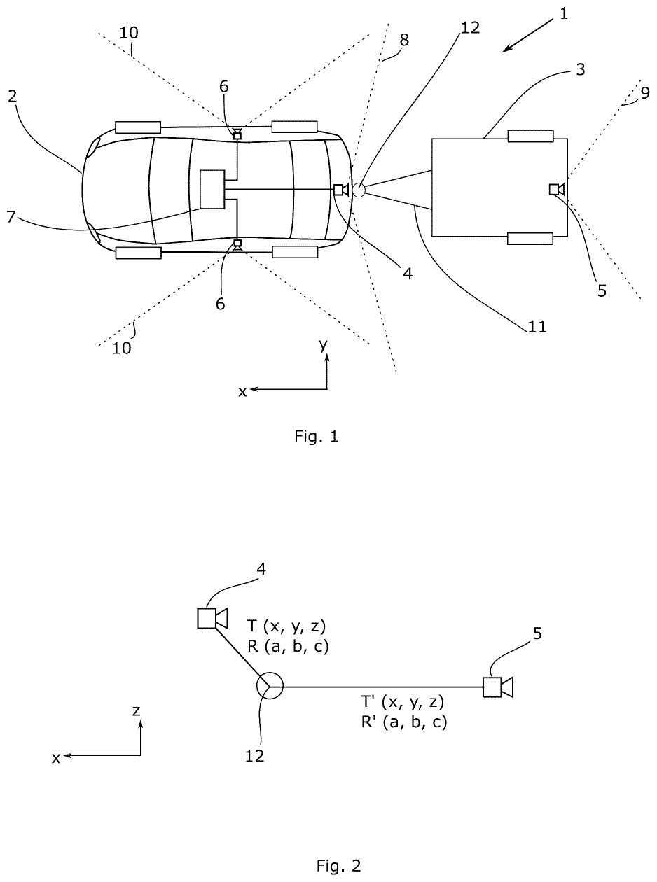

A vehicle combination 1 is depicted in FIG. 1. The vehicle combination 1 includes an example embodiment of a vehicle according to the present disclosure as a towing vehicle 2 and a trailer 3 coupled to the towing vehicle 2. The towing vehicle 2 is embodied as a motor vehicle, by way of example as a passenger car or a truck.

A first camera 4 is arranged on the tail of the towing vehicle 2. The first camera 4 can be, by way of example, a back-up camera of the towing vehicle 2. A second camera 5 is arranged on a back of the trailer 3, which in this case faces away from the towing vehicle 2. The first camera 4 and the second camera 5 form a camera arrangement of the vehicle combination 1. The camera arrangement can optionally also include one or more third cameras 6 which, by way of example, capture the environment of the vehicle combination 1 to the side of the towing vehicle 2 or to the side of the trailer 3. The cameras 4-6 of the camera arrangement are connected, for example wirelessly or via a wired communication link, to a controller 7 which is configured to perform a method for generating a view of the surroundings at least partially located behind the trailer 3 of the vehicle combination 1.

The first camera 4 arranged on the towing vehicle 2 captures at least one section of the trailer 3 within a capturing range 8 of the first camera 4, which is shown by dashed lines. The second camera 5 captures at least one subregion of the surroundings behind the trailer 3 and has a capturing range 9 which is likewise represented by dashed lines in FIG. 1. The third cameras 6, which are likewise optionally provided, each have a capturing range 10 which covers a subregion of the surroundings to the side of the vehicle combination 1.

The trailer 3 includes a coupling section 11, with which it is coupled at a coupling point 12, by way of example its trailer coupling, of the towing vehicle 2. The trailer 3 is at least laterally swivelable via the coupling section 11. In this connection, “laterally swivelable” refers to a pivoting of the trailer 3 relative to the towing vehicle 2 in a plane which is spanned by the vehicle longitudinal direction x and the vehicle transverse direction y.

To generate the view of the surroundings, the controller 7 receives the camera images from the first camera 4, the second camera 5 as well as, possibly, also the third cameras 6. The controller 7 generates a view of the surroundings, which at least partially depicts the surroundings of the vehicle combination, from the received camera images. The view of the surroundings can be displayed, by way of example, to a driver of the towing vehicle 2 via a representation device (not represented) arranged inside the towing vehicle 2.

The controller 7 is set up to receive at least one first camera image from the first camera 4 and at least one second camera image from the second camera 5 in a first step. The controller 7 subsequently determines at least one segment which corresponds to an end face, directed toward the towing vehicle 2, of the trailer 3 in the first camera image 4. The segment is determined by means of segmentation of the first camera image, which is described in even more detail below. The controller 7 subsequently generates the view of the surroundings from the first camera image and the second camera image as a function of the determined segment, wherein at least part of the segment is supplemented with image data from the second camera image.

In order to be able to supplement the segment with the image data of the second camera image, an item of position information which describes the relative arrangement between the first camera 4 and the second camera 5 is in particular stored in the controller 7. Even when using multiple first cameras 4, multiple second cameras 5 and/or when optionally using one or more third cameras 6, the respective relative, initial arrangements of the cameras 4, 5, 6 with respect to one another can be stored in the form of position information, in order to make it possible to merge the respective image data from the camera images as seamlessly as possible.

The position information for the first camera 4 and the second camera 5 is represented schematically in FIG. 2. The position information includes, for example, for the first camera 4, a translation vector T as well as a rotation vector R, which describe the translational or rotational arrangement of the first camera 4 in relation to the coupling point 12 of the trailer 3. Accordingly, the position information for the second camera 5 describes the translational offset of the second camera 5 from the coupling point 12 with a translation vector T′ and the rotational offset from the coupling point 12 with a rotation vector R'.

The respective components x, y, z of the vectors T, T′ and the components a, b, c of the vectors R and R′ can initially be established, for example, by a measurement and/or on the basis of image data determined by the first camera 4 and/or the second camera 5. During a driving operation of the vehicle combination 1, the vectors or their components can at least partially be redetermined in order to be able to correctly represent the view of the surroundings at least approximately in real time. Corresponding vectors can likewise be determined accordingly for further first cameras 4, further second cameras 5 and/or one or more third cameras 6 which are optionally provided.

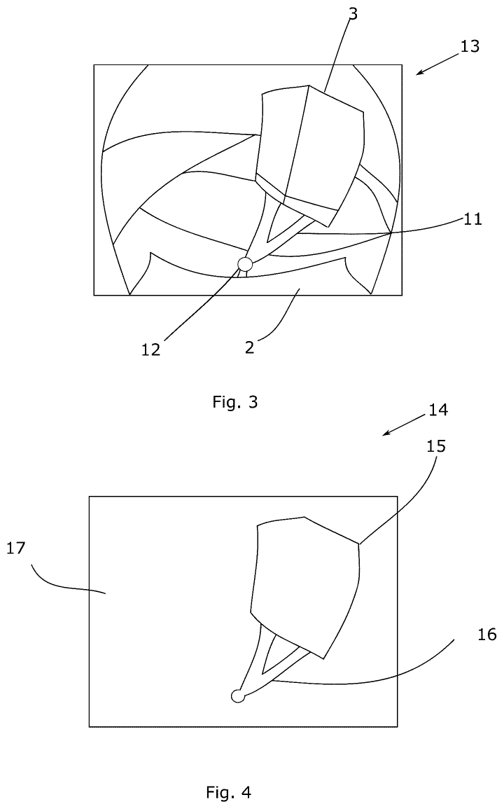

A first camera image 13 which was acquired, for example, with a first camera 4 including a fisheye lens is schematically represented in FIG. 3 to explain the segmentation of a first camera image. The first camera image 13 shows a subregion of the environment of the vehicle combination 1 behind the towing vehicle 2, wherein an end face of the trailer 3 facing the towing vehicle can also be recognized. Further, the coupling section 11, the coupling point 12 as well as further features of the surroundings are also depicted in the first camera image 13. In the present case, all of the depictions in the first camera image 13 have the distortion which is characteristic of a fisheye lens.

The first camera image 13 is subsequently segmented by a segmentation algorithm implemented in the controller 7. An example of a segmented camera image 14 is represented in FIG. 4. At least one segment 15 of the first camera image 13 corresponding to the end face, directed toward the towing vehicle 2, of the trailer 3 is determined with the aid of the segmentation. The size and the geometry of the segment 15 are governed by the actual dimensions of the trailer 3. In addition to a structure of the trailer 3, the segment 15 can also include a load of the trailer 3 arranged uncovered on the trailer 3, so that different types of trailers and/or different loading states of a trailer can advantageously be recognized and superimposed with image data from a second camera image of the second camera 5 during the generation of the view of the surroundings. Consequently, a view of the surroundings can be advantageously generated in which the trailer 3 or the end face, facing the towing vehicle 2, of the trailer 3 appears transparent.

Furthermore, at least one further segment 16 is determined by the segmentation of the first camera image 13, wherein the further segment 16 corresponds to the coupling section 11 of the trailer 3. The background of the first camera image 13 forms a background segment 17. The view of the surroundings is subsequently generated by replacing the entire segment 15 or at least part of the segment 15 by image data from a second camera image generated with the aid of the second camera 5. By way of example, the image data of the first camera image 13 can remain in the background segment 17, so that a rear view from the towing vehicle 2, which is not blocked by the trailer 3, is produced with the aid of the image data of the second camera image inserted into the segment 15.

That is to say that to generate the transparent view, the segment 15 corresponding to the end face of the trailer 3 in the first camera image 13 is wholly or at least partially supplemented with image data from the second camera image. The image region outside the segment 15, that is to say the further segment 16 and the background segment 17, can in particular continue to contain the image data from the first camera image, since these depict the surroundings of the vehicle combination 1 which are not obscured by the trailer 3 in these regions.

The second camera image can be edited, e.g., by cropping and rotating or by rotational and/or translational transformation, for the supplementation of the segment 15 with the image data from the second camera image. Additionally or alternatively, further changes and/or editing can also be made to the second camera image, by way of example a projection onto a plane corresponding to the segment 15 in the first camera image 13 and/or comparable transformations.

The segmentation of the first camera image 13 is carried out, for example, by a neural network implemented in the controller 7. The segmentation can be carried out, by way of example, by semantic segmentation, in particular a content-guided network algorithm.

In addition to the geometry of the trailer 3 as well as, possibly, a load transported on the trailer 3, the shape of the segment 15 also depends on the lateral swivel angle of the trailer 3, that is to say, on the angle at which the trailer is pivoted around the coupling point 12. The replacement of at least part of the segment 15 in the first camera image 13 by image data from the second camera image, which was described above, is in particular carried out as a function of the swivel angle of the trailer 3. As a result, the image data from the second camera image which are suitable for the current driving situation of the vehicle combination 1 can be selected for a seamless representation of the surroundings in the view of the surroundings and can be inserted into the segment 15. By segmenting the first camera image 13, the lateral swivel angle between the towing vehicle 2 and the trailer 3 can also be advantageously determined.

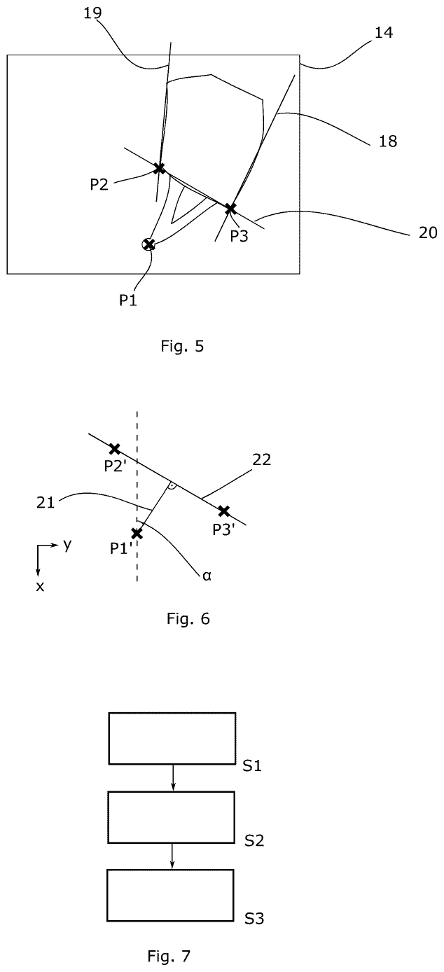

The first step of determining the swivel angle from the segmented first camera image 14 is graphically represented in FIG. 5. The lateral swivel angle can be determined as a function of the position of one or more edges of the at least one segment 15 in the first camera image 13 as well as a position P1 of the coupling point 12 at which the trailer 3 is laterally swivelably coupled to the towing vehicle 2. To this end, the respective intersection points P2, P3 of two lateral edges 18, 19 of the segment 15, which correspond to the lateral edges of the trailer 3, having a lower edge 20 of the segment 15, which corresponds to the lower edge of the trailer 3, are determined. The points P1, P2 and P3 are subsequently projected onto a ground plane extending parallel to a roadway plane of the vehicle combination 1.

FIG. 6 shows a projection of the intersection points P2, P3 and the position P1 of the coupling point 12 onto the ground plane extending in the vehicle longitudinal direction x and in the vehicle transverse direction y, wherein the projections of the points P1, P2 and P3 onto the ground plane are designated P1′, P2′ and P3′. The lateral swivel angle a can then be determined as the angle between the longitudinal direction x of the towing vehicle 2 and a perpendicular 21 which is dropped through the point P1′ onto a straight line 22 between the projections P2′, P3′ of the intersection points P2, P3.

The view of the surroundings can in particular be generated as a function of the lateral swivel angle a. Additionally or alternatively, when a swivel angle limit value is exceeded by the determined swivel angle a, it is possible for a warning to be output to a driver of the towing vehicle 2 and/or a control command to be output to an actuator of the towing vehicle 2.

An example embodiment of a method for training a neural network for the segmentation of an image is represented in FIG. 7. The method includes the steps of:
providing (S1) at least one training data set including multiple training images which each depict at least one end face, directed toward an acquisition position of the training image, of a trailer 3, as a ground truth,
assigning (S2) at least one segment 15 to each of the training images, wherein each segment 15 corresponds to the end face of the trailer 3 in the training image, and
optimizing (S3) the neural network in terms of a conformity between the at least one segment 15 and the end face of the trailer 3 described by the ground truth.

It is possible that at least some of the training images depict the coupling section 11 of the trailer 3 as a further ground truth, wherein a further segment 16 is assigned to the coupling section 11 and the neural network is also optimized in terms of a conformity between the at least one further segment 16 and the coupling section 11 described by the further ground truth.

1. A method for generating a view of the surroundings located at least partially behind a trailer of a vehicle combination comprising the trailer and a towing vehicle from camera images obtained with the aid of a camera arrangement, wherein the camera arrangement has at least one first camera capturing at least one section of the trailer as well as at least one second camera capturing at least one subregion of the surroundings behind the trailer, the method comprising:
capturing at least one first camera image with the at least one first camera and at least one second camera image with the second camera,
determining at least one segment of the first camera image which corresponds to an end face, directed toward the towing vehicle, of the trailer, in the first camera image by segmenting the first camera image, and
generating the view of the surroundings from the first camera image and the second camera image as a function of the determined segment, wherein at least part of the segment is supplemented with image data from the second camera image.

2. The method according to claim 1, wherein a lateral swivel angle of the trailer is determined as a function of a position of one or more edges of the at least one segment in the first camera image as well as a position of a coupling point at which the trailer is laterally swivelably coupled to the towing vehicle, and wherein at least one of the view of the surroundings is generated as a function of the lateral swivel angle, or when a swivel angle limit value is exceeded, at least one of a warning is output to a driver of the towing vehicle or a control command is output to an actuator of the towing vehicle.

3. The method according to claim 2, wherein the respective intersection points of two lateral edges of the segment, which correspond to the lateral edges of the trailer, having a lower edge of the segment which corresponds to a lower edge of the trailer, are determined, wherein the lateral swivel angle is determined from a projection of the intersection points and the position of the coupling point onto a ground plane extending parallel to a roadway plane of the vehicle combination.

4. The method according to claim 1, wherein at least one further segment is determined by segmenting the first camera image, and wherein the further segment corresponds to a coupling section of the trailer.

5. The method according to claim 1, wherein at least one of
the segmentation of the first camera image is carried out by a neural network or
the segmentation of the first camera image is carried out by semantic segmentation.

6. The method according to claim 1, wherein a camera arrangement is used which uses one or more third cameras each of which captures a lateral region surrounding at least one of the towing vehicle or the trailer, and wherein the view of the surroundings is additionally generated from one or more third camera images of the one or more third cameras.

7. A method for training a neural network for the segmentation of an image, for use in a method according to claim 1, comprising:
providing at least one training data set comprising multiple training images which each depicts at least one end face, directed toward an acquisition position of the training image, of a trailer as a ground truth,
assigning at least one segment to each of the training images, wherein each segment corresponds to the end face of the trailer in the training image, and
optimizing the neural network in terms of a conformity between the at least one segment and the end face of the trailer described by the ground truth.

8. The method according to claim 7, wherein at least some of the training images depict a coupling section of the trailer as a further ground truth, wherein a further segment is assigned to the coupling section and the neural network is also optimized in terms of a conformity between the at least one further segment and the coupling section described by the further ground truth.

9. A controller configured to receive the at least one first camera image and the at least one second camera image, wherein the controller is set up to perform a method according to claim 1.

10. A vehicle comprising a controller according to claim 9.

11. A computer program comprising instructions which prompt a computing device to carry out a method according to claim 1.
